(19) United States
(12) Patent Application Publication
(10) Pub. No.: US 2021/0399402 A1
(43) Pub. Date: Dec. 23, 2021

(54) ANTENNA ASSEMBLY

(71) Applicant: LUXSHARE-ICT CO., LTD., Taipei City (TW)

(72) Inventors: Chen-Hung Chou, Taipei City (TW); Shih-Tsung Kan, Taipei City (TW); Yu-Wei Chen, Taipei City (TW)

(73) Assignee: LUXSHARE-ICT CO., LTD., Taipei City (TW)

(21) Appl. No.: 17/463,718

(22) Filed: Sep. 1, 2021

(30) Foreign Application Priority Data
Mar. 18, 2021 (TW) 110109852

(51) Int. Cl. H01Q 1/02; H01Q 1/42

(52) U.S. Cl. CPC H01Q 1/02; H01Q 1/42

(57) ABSTRACT

An antenna assembly includes a base, a lower shell, a heat-dissipating support, an antenna body, and an upper shell. The base includes a base body and a connecting portion connected to each other. The lower shell includes a pivotal base. The pivotal base is located at a first end of the lower shell, and a second end of the lower shell is connected to the connecting portion. The heat-dissipating support includes a bottom portion, a fixed portion, and an extension portion connected in sequence, and the bottom portion is pivotally disposed on the pivotal base. The antenna body includes an adapter board and a first antenna connected to each other. The adapter board includes a fixed end fixed to the extension portion. The upper shell includes an accommodation space configured to accommodate the heat-dissipating support and the antenna body, and the fixed portion is fixed to the upper shell.

### CROSS-REFERENCE TO RELATED APPLICATION

This non-provisional application claims priority under 35 U.S.C. § 119(a) to Patent Application No. 110109852 filed in Taiwan, R.O.C. on Mar. 18, 2021, the entire contents of which are hereby incorporated by reference.

### BACKGROUND

### Technical Field

The present invention provides an antenna assembly, and in particular, an external antenna assembly.

### Related Art

Currently, millimeter wave antennas are mostly disposed inside electronic devices. For example, a millimeter wave antenna is disposed in a laptop computer. Since the millimeter wave antenna is fixedly disposed in the electronic device, a range covered by the antenna beam is only a fixed angle of 120 degrees, which easily causes poor signals of the antennas. In addition, the millimeter wave antenna is likely to be overheated due to being disposed in the electronic device.

### SUMMARY

In view of this, according to some embodiments, an antenna assembly includes a base, a lower shell, a heat-dissipating support, an antenna body, and an upper shell. The base includes a base and a connecting portion connected to each other. The lower shell includes a pivotal base, the pivotal base is located at a first end of the lower shell, and a second end of the lower shell is connected to the connecting portion. The heat-dissipating support includes a bottom portion, a fixed portion, and an extension portion connected in sequence, and the bottom portion is pivotally disposed on the pivotal base. The antenna body includes an adapter board and a first antenna connected to each other, the adapter board includes a fixed end, and the fixed end is fixed to the extension portion. The upper shell includes an accommodation space, the accommodation space is configured to accommodate the heat-dissipating support and the antenna body, and the fixed portion is fixed to the upper shell.

According to some embodiments, the base body has a first opening, the connecting portion has a second opening, and the first opening is in communication with the second opening. The pivotal base has a through hole, the adapter board includes a contact terminal, and the contact terminal is opposite to the fixed end. The antenna assembly includes a cable, and the cable extends through the first opening, the second opening, and the through hole, and is electrically connected to the contact terminal.

According to some embodiments, the lower shell includes a bearing surface, the bearing surface is located at the first end of the lower shell, and the pivotal base is located on the bearing surface. The bottom portion has a pivotal hole, and the pivotal hole is sleeved on the pivotal base, so that the heat-dissipating support is pivoted about the pivotal axis of the pivotal base.

According to some embodiments, the upper shell includes an underside and a guide post located on the underside, the lower shell includes a guide rail, the guide rail is located in the bearing surface, and the guide post is located in the guide rail.

According to some embodiments, the lower shell envelops at least part of the connecting portion, the connecting portion has a pivotal shaft, the lower shell has a pivotal hole, the pivotal shaft is located in the pivotal hole, and an included angle is formed between the pivotal shaft and the pivotal axis.

According to some embodiments, the lower shell envelops at least part of the connecting portion, the connecting portion has a pivotal shaft, the lower shell has a pivotal hole, and the pivotal shaft is located in the pivotal hole.

According to some embodiments, the connecting portion includes a plurality of positioning elements, the shell has a matching element, and when the lower shell is pivoted relative to the connecting portion about the pivotal shaft, the matching element is selectively located in one of the positioning elements.

According to some embodiments, the antenna assembly further includes an adhering member. One side of the adhering member is adhered to the fixed end, and the other side adhered to the extension portion, so that the fixed end is fixed to the extension portion.

According to some embodiments, the extension portion includes a first extension portion and a second extension portion connected in sequence, and the adapter board includes an adhering end. The adhering end is spaced apart from the first extension portion by a distance, a part of the first antenna is connected to the adhering end, and the other part of the first antenna is connected to the second extension portion.

According to some embodiments, the antenna body further includes a second antenna, one part of the second antenna is connected to the extension portion, and the other part of the second antenna protrudes from the extension portion.

According to some embodiments, the base body further includes a pivotal portion and a snap-fit portion connected to each other. The pivotal portion is pivotally connected to an external device, and the snap-fit portion is snap-fitted to an inner edge of the external device.

Detailed features and advantages of the present invention are described in detail in the following implementations, which are sufficient for any person skilled in the art to understand the technical content of the present invention and implement the operation accordingly. According to the content, the scope of patent application, and the drawings disclosed in this specification, any person skilled in the art can easily understand the related objective and advantage of the present invention.

### BRIEF DESCRIPTION OF THE DRAWINGS

FIG. 1A illustrates a schematic diagram (I) of an antenna assembly according to some embodiments.

FIG. 1B illustrates a schematic exploded view (I) of the antenna assembly according to some embodiments.

FIG. 1C illustrates a schematic exploded view (II) of the antenna assembly according to some embodiments.

FIG. 2 illustrates a schematic diagram of a base according to some embodiments.

FIG. 3 illustrates a schematic diagram of a lower shell according to some embodiments.

FIG. 4 illustrates a schematic diagram of an upper shell from another perspective according to some embodiments.

FIG. 5 illustrates a schematic diagram of the upper shell in a rotating state according to some embodiments.

FIG. 6 illustrates a schematic diagram of the lower shell from another perspective according to some embodiments.

FIG. 7 illustrates a schematic diagram of a combination of an antenna body and a heat-dissipating support according to some embodiments.

FIG. 8 illustrates a schematic diagram of the combination of the antenna body and the heat-dissipating support from another perspective according to some embodiments.

FIG. 9 illustrates a schematic diagram of a combination of the antenna assembly and an external device according to some embodiments.

FIG. 10 illustrates a schematic diagram (II) of the antenna assembly according to some embodiments.

FIG. 11 illustrates a schematic exploded view (III) of the antenna assembly according to some embodiments.

### DETAILED DESCRIPTION

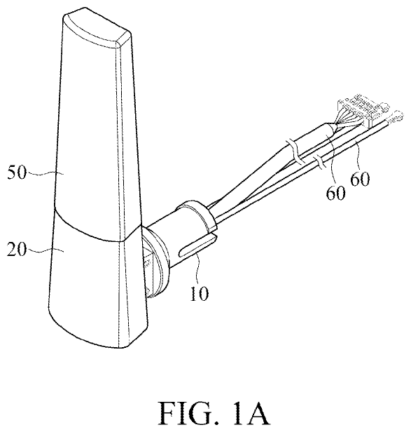

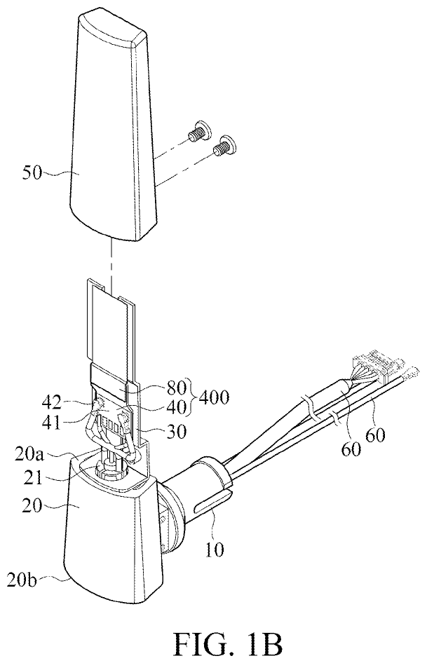

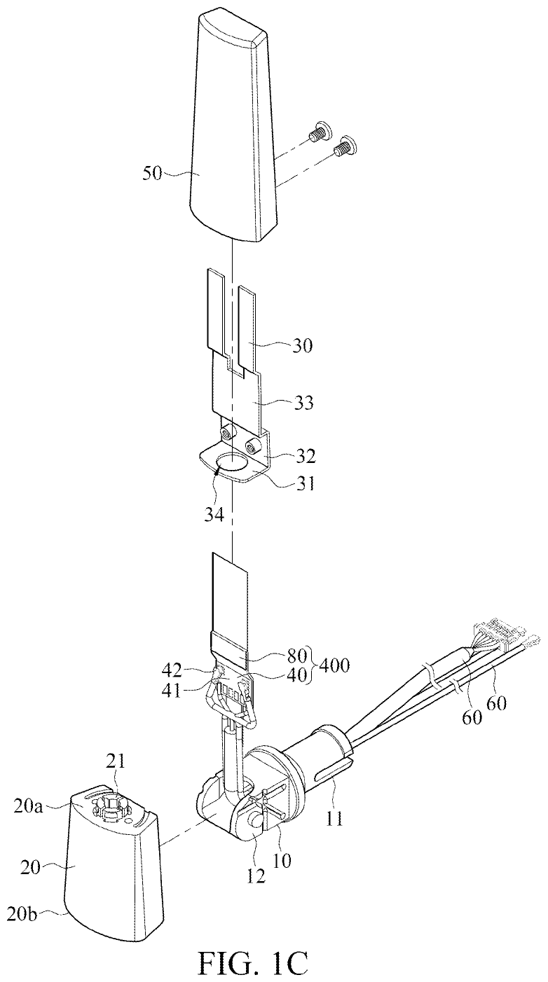

Referring to FIG. 1A to FIG. 1C, FIG. 1A illustrates a schematic diagram of an antenna assembly according to some embodiments, FIG. 1B illustrates a schematic exploded view (I) of the antenna assembly according to some embodiments, and FIG. 1C illustrates a schematic exploded view (II) of the antenna assembly according to some embodiments.

Referring to FIG. 1A to FIG. 1C, the antenna assembly includes a base 10, a lower shell 20, a heat-dissipating support 30, an antenna body 400, and an upper shell 50. The base 10 includes a base body 11 and a connecting portion 12 connected to each other. The lower shell 20 includes a pivotal base 21, the pivotal base 21 is located at a first end 20a of the lower shell 20, and a second end 20b of the lower shell 20 is configured to be connected to the connecting portion 12. The heat-dissipating support 30 includes a bottom portion 31, a fixed portion 32, and an extension portion 33 connected in sequence, and the bottom portion 31 is pivotally disposed on the pivotal base 21. In some embodiments, the bottom portion 31 and the fixed portion 32 are perpendicular to each other, so that the bottom portion 31 and the fixed portion 32 are approximately L-shaped from a side view. The antenna body 400 includes an adapter board 40 and a first antenna 80 connected to each other. The adapter board 40 is, for example, but not limited to, a PCB board for signal conversion, and the first antenna 80 is, for example, but not limited to a millimeter wave antenna. The adapter board 40 includes a fixed end 41, and the fixed end 41 is fixed to the extension portion 33. The upper shell 50 includes an accommodation space (not shown in the figure). The accommodation space is configured to accommodate the heat-dissipating support 30 and the antenna body 400, and the fixed portion 32 is fixed to the upper shell 50. The fixed portion 32 may be fixed to the upper shell 50 through a joint element such as but not limited to screws.

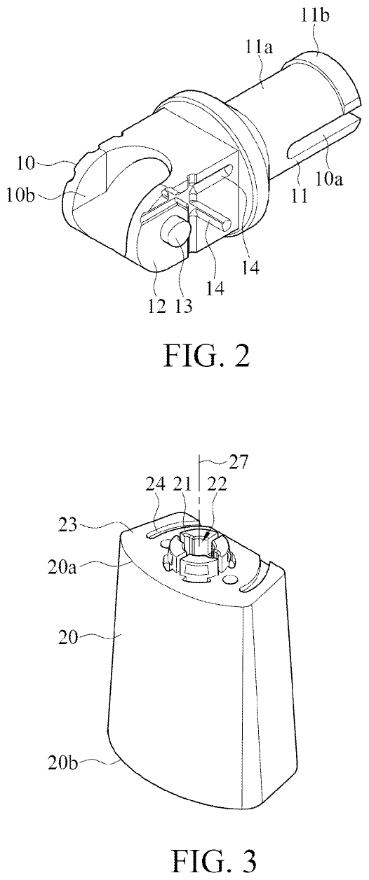

Referring to FIG. 2 to FIG. 3, FIG. 2 illustrates a schematic diagram of a base according to some embodiments, and FIG. 3 illustrates a schematic diagram of a lower shell according to some embodiments.

The base 10 includes a base body 11 and a connecting portion 12 connected to each other. The base body 11 has a first opening 10a, and the connecting portion 12 has a second opening 10b. In this way, the first opening 10a is in communication with the second opening 10b. The pivotal base 21 of the lower shell 20 has a through hole 22. Referring to FIG. 1C together, the adapter board 40 includes a contact terminal 42, and the contact terminal 42 is opposite to the fixed end 41. Further, the contact terminal 42 may be located at any position on the fixed end 41. The antenna assembly further includes a cable 60. The cable 60 extends through the first opening 10a, the second opening 10b, and the through hole 22, and is electrically connected to the contact terminal 42 after passing through the base 10 and the lower shell 20. In some embodiments, the cable 60 includes a signal cable and a power cable. In this way, the cables 60 with different functions are respectively connected to the contact terminals 42 corresponding to the cables.

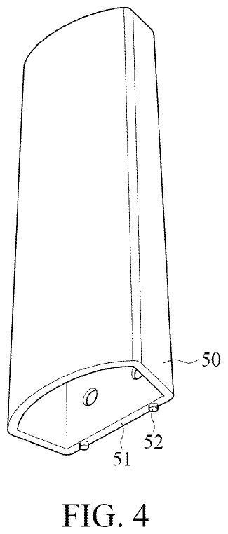

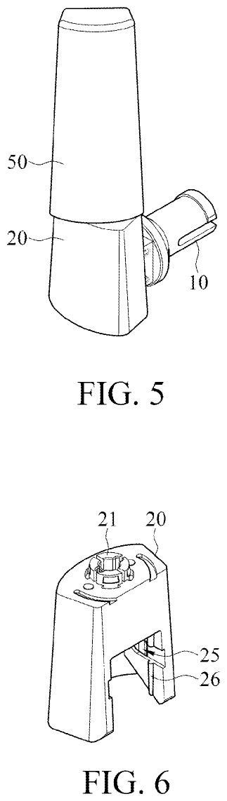

Referring to FIG. 1B, FIG. 1C, and FIG. 3 to FIG. 5 together, FIG. 4 illustrates a schematic diagram of an upper shell from another perspective according to some embodiments, and FIG. 5 illustrates a schematic diagram of the upper shell in a rotating state according to some embodiments. As shown in FIG. 3, the lower shell 20 includes a bearing surface 23, and the bearing surface 23 is located at the first end 20a of the lower shell 20. In this way, the pivotal base 21 is located on the bearing surface 23. The bottom portion 31 of the heat-dissipating support 30 has a pivotal hole 34 (shown in FIG. 1C). The pivotal hole 34 is sleeved on the pivotal base 21. In this way, the heat-dissipating support 30 is pivoted about a pivotal axis 27 of the pivotal base 21. Moreover, the adapter board 40 of the antenna body 400 is fixed to the extension portion 33 of the heat-dissipating support 30. Therefore, when the heat-dissipating support 30 is pivoted about the pivotal axis 27 of the pivotal base 21, the antenna body 400 is to be accordingly pivoted about the pivotal axis 27 of the pivotal base 21.

Furthermore, as shown in FIG. 4, the upper shell 50 includes an underside 51 and a guide post 52 located on the underside 51. As shown in FIG. 3, the lower shell 20 includes a guide rail 24, and the guide rail 24 is located in the bearing surface 23 and has a curvature. When the upper shell 50 is assembled onto the lower shell 20, the guide post 52 is located in the guide rail 24. In this way, when the heat-dissipating support 30 is pivoted about the pivotal axis 27 of the pivotal base 21, since the fixed portion 32 of the heat-dissipating support 30 is fixed to the upper shell 50, the upper shell 50 is to be accordingly pivoted about the pivotal axis 27 of the pivotal base 21. In addition, through the arrangement of the guide post 52 being located in the guide rail 24, when the upper shell 50 is pivoted about the pivotal axis 27 of the pivotal base 21, the guide post 52 moves along the guide rail 24, and the upper shell 50 is to be limited by the guide rail 24 and can be pivoted at a certain angle.

In some embodiments, two guide rails 24 are provided and are respectively located on two sides of the pivotal base 21. In addition, a number of guide posts 52 correspond to the guide rails 24. In this way, the angle at which the upper shell 50 is pivoted is to be limited by the guide rails 24 on both sides of the pivotal base 21, and the upper shell is rotated in clockwise and counterclockwise directions by 45 degrees (as shown in FIG. 5). Furthermore, the angle range at which the upper shell 50 can be pivoted is 90 degrees.

Referring to FIG. 2 and FIG. 6, FIG. 6 illustrates a schematic diagram of the lower shell from another perspective according to some embodiments. When the second end 20b (as shown in FIG. 3) of the lower shell 20 is connected to the connecting portion 12, the lower shell 20 envelops at least part of the connecting portion 12. In this way, the connecting portion 12 has a pivotal shaft 13 (as shown in FIG. 2), and the lower shell 20 has a pivotal hole 25. When the lower shell 20 is connected to the connecting portion 12, the pivotal shaft 13 is located in the pivotal hole 25, so that an included angle is formed between the pivotal shaft 13 and the pivotal axis 27. Furthermore, the lower shell 20 can be pivoted about the pivotal shaft 13 by means of the pivotal shaft 13 being located in the pivotal hole 25, and an included angle is formed between the lower shell and the base 10.

In some embodiments, as shown in FIG. 2, the connecting portion 12 includes a plurality of positioning elements 14. The positioning element 14 is, for example, but not limited to positioning grooves. The lower shell 20 has a matching element 26 (as shown in FIG. 6). The matching element 26 corresponds to the positioning element 14 and can be embedded in the positioning element 14. When the lower shell 20 is pivoted relative the connecting portion 12 about the pivotal shaft 13, the matching element 26 can be selectively located in one of the positioning elements 14, so that different angles are formed between the lower shell 20 and the base 10.

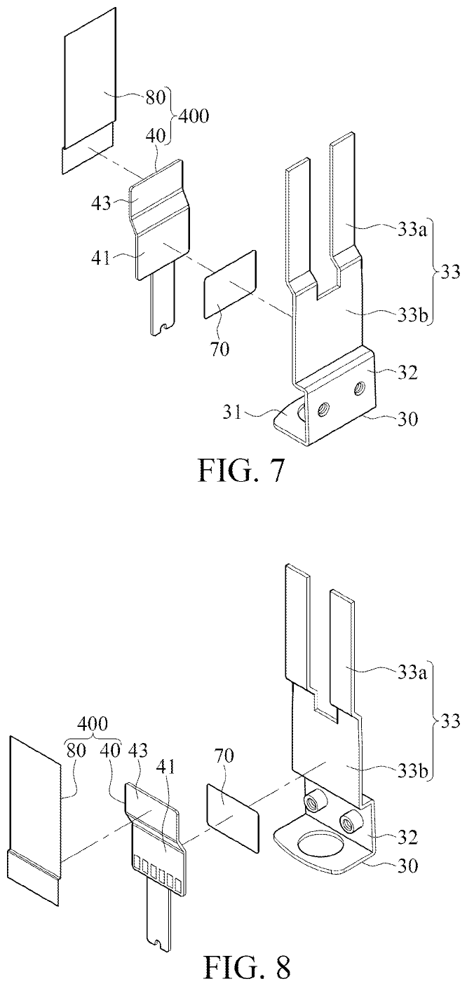

Referring to FIG. 7 and FIG. 8, FIG. 7 illustrates a schematic diagram of a combination of an antenna body and a heat-dissipating support according to some embodiments, and FIG. 8 illustrates a schematic diagram of the combination of the antenna body and the heat-dissipating support from another perspective according to some embodiments.

The antenna assembly further includes an adhering member 70. One side of the adhering member is adhered to the fixed end 41, and the other side adhered to the extension portion 33, so that the fixed end 41 is fixed to the extension portion 33. In this way, the antenna body 400 can be fixed to the heat-dissipating support 30. In addition, the extension portion 33 includes a first extension portion 33b and a second extension portion 33a connected in sequence. The adapter board 40 includes an adhering end 43, a part of the first antenna 80 is connected to the adhering end 43, and the adhering end 43 is located on the first extension portion 33b and is spaced apart from the first extension portion 33b by a distance. The other part of the first antenna 80 is connected to the second extension portion 33a. The adhering member 70 is, for example, but not limited to, a double-sided adhesive tape.

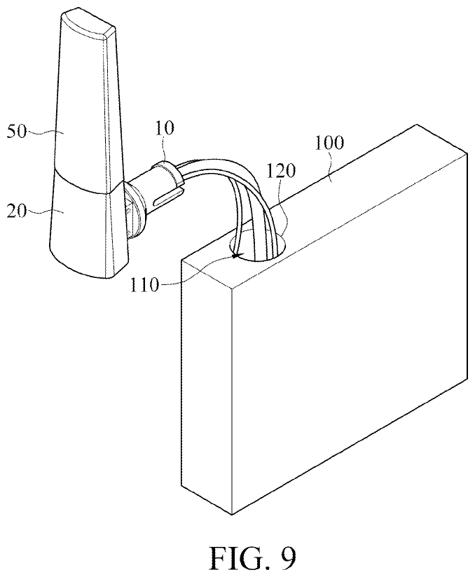

Referring to FIG. 2 and FIG. 9, FIG. 9 illustrates a schematic diagram of a combination of the antenna assembly and an external device according to some embodiments.

An external device 100 is an electronic device, for example, but not limited to a tablet computer, a notebook computer, or the like. The base body 11 includes a pivotal portion 11a and a snap-fit portion 11b connected to each other. An outer diameter of the snap-fit portion 11b is greater than an outer diameter of the pivotal portion 11a. The external device 100 includes a disposing hole 110 for disposing the antenna assembly on the external device 100. In this way, the pivotal portion 11a extends through the disposing hole 110, and the snap-fit portion 11b is snap-fitted to an inner edge 120 of the external device 100, so that the antenna assembly is located on the external device 100 and is pivoted about the pivotal portion 11a.

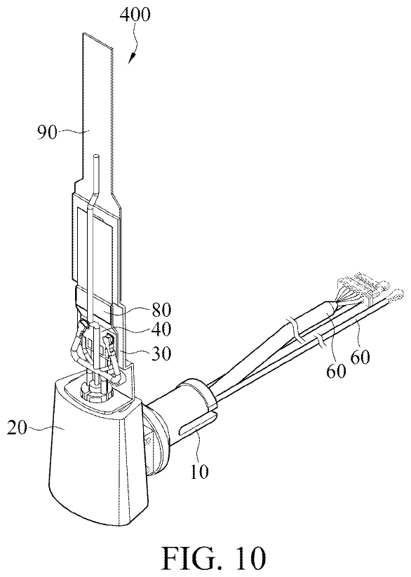

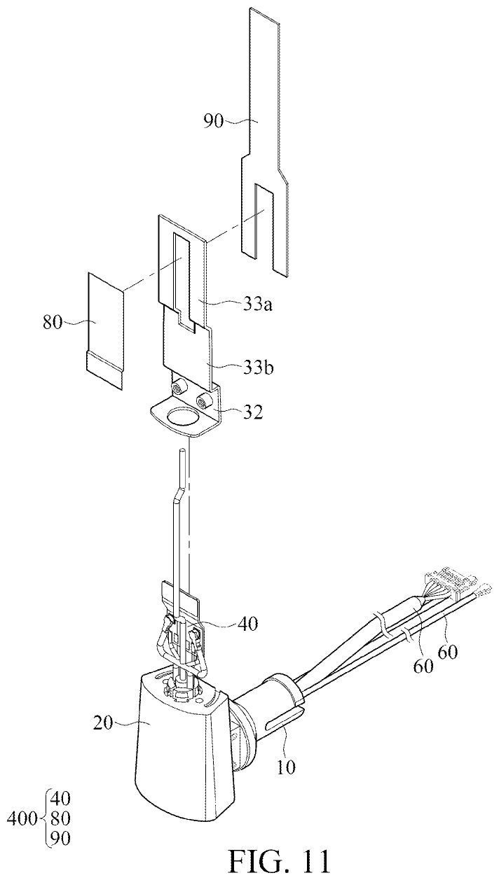

Referring to FIG. 10 and FIG. 11, FIG. 10 illustrates a schematic diagram (II) of the antenna assembly according to some embodiments, and FIG. 11 illustrates a schematic exploded view (III) of the antenna assembly according to some embodiments.

In some embodiments, the antenna body 400 further includes a second antenna 90. The second antenna 90 is, for example, but not limited to, a Wi-Fi antenna. The second antenna 90 is connected to the heat-dissipating support 30 and is located on a different surface of the adapter board 40 from the first antenna 80, that is, the adapter board 40 is located between the second antenna 90 and the first antenna 80. In some embodiments, the second antenna 90 and the first antenna 80 may be disposed on the same surface of the adapter board 40. When the second antenna 90 is connected to the heat-dissipating support 30, one part of the second antenna 90 is connected to the extension portion 33, and the other part of the second antenna 90 protrudes from the extension portion 33. Furthermore, the part of the second antenna 90 is connected to the second extension portion 33a, and the other part of the second antenna 90 protrudes from an end of the second extension portion 33a. In this way, the cable 60 can extend through the first antenna 80 and an upper part of the adapter board 40 and is electrically connected to the second antenna 90.

Based on the above, in some embodiments, an antenna unit and the heat-dissipating support are rotated by the antenna assembly through the rotation of the upper shell relative to the lower shell, so that the antenna unit can increase the coverage range of antenna beams with the angle of rotation, which solves at least one of the problems of an insufficient coverage range of the conventional antenna beam and overheating easily caused by disposing the antenna in the electronic device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna assembly, comprising:
a base comprising a base body and a connecting portion connected to each other;
a lower shell comprising a pivotal base, wherein the pivotal base is located at a first end of the lower shell, and a second end of the lower shell is connected to the connecting portion;
a heat-dissipating support comprising a bottom portion, a fixed portion, and an extension portion connected in sequence, wherein the bottom portion is pivotally disposed on the pivotal base;
an antenna body comprising an adapter board and a first antenna connected to each other, wherein the adapter board comprises a fixed end, and the fixed end is fixed to the extension portion; and
an upper shell comprising an accommodation space configured to accommodate the heat-dissipating support and the antenna body, and the fixed portion is fixed to the upper shell.

2. The antenna assembly according to claim 1, wherein the base body has a first opening, the connecting portion has a second opening, the first opening is in communication with the second opening, the pivotal base has a through hole, the adapter board comprises a contact terminal opposite to the fixed end, the antenna assembly comprises a cable, and the cable extends through the first opening, the second opening, and the through hole and is electrically connected to the contact terminal.

3. The antenna assembly according to claim 1, wherein the lower shell comprises a bearing surface, the bearing surface is located at the first end of the lower shell, the pivotal base is located on the bearing surface, the bottom portion has a pivotal hole, and the pivotal hole is sleeved on the pivotal base, so that the heat-dissipating support is pivoted about a pivotal axis of the pivotal base.

4. The antenna assembly according to claim 3, wherein the upper shell comprises an underside and a guide post located on the underside, the lower shell comprises a guide rail, the guide rail is located in the bearing surface, and the guide post is located in the guide rail.

5. The antenna assembly according to claim 4, wherein the lower shell envelops at least part of the connecting portion, the connecting portion has a pivotal shaft, the lower shell has a pivotal hole, the pivotal shaft is located in the pivotal hole, and an included angle is formed between the pivotal shaft and the pivotal axis.

6. The antenna assembly according to claim 3, wherein the lower shell envelops at least part of the connecting portion, the connecting portion has a pivotal shaft, the lower shell has a pivotal hole, the pivotal shaft is located in the pivotal hole, and an included angle is formed between the pivotal shaft and the pivotal axis.

7. The antenna assembly according to claim 1, wherein the lower shell envelops at least part of the connecting portion, the connecting portion has a pivotal shaft, the lower shell has a pivotal hole, and the pivotal shaft is located in the pivotal hole.

8. The antenna assembly according to claim 2, wherein the lower shell envelops at least part of the connecting portion, the connecting portion has a pivotal shaft, the lower shell has a pivotal hole, and the pivotal shaft is located in the pivotal hole.

9. The antenna assembly according to claim 8, wherein the connecting portion comprises a plurality of positioning elements, the lower shell has a matching element, and when the lower shell is pivoted relative to the connecting portion about the pivotal axis, the matching element is selectively located in one of the positioning elements.

10. The antenna assembly according to claim 1, further comprising an adhering member, one side of the adhering member is adhered to the fixed end, and the other side is adhered to the extension portion, so that the fixed end is fixed to the extension portion.

11. The antenna assembly according to claim 1, wherein the extension portion comprises a first extension portion and a second extension portion connected in sequence, the adapter board comprises an adhering end, the adhering end is spaced apart from the first extension portion by a distance, one part of the first antenna is connected to the adhering end, and the other part of the first antenna is connected to the second extension portion.

12. The antenna assembly according to claim 1, wherein the antenna body further comprises a second antenna, one part of the second antenna is connected to the extension portion, and the other part of the second antenna protrudes from the extension portion.

13. The antenna assembly according to claim 1, wherein the base body further comprises a pivotal portion and a snap-fit portion connected to each other, the pivotal portion is pivotally connected to an external device, and the snap-fit portion is snap-fitted to an inner edge of the external device.
